(19) United States
(12) Patent Application Publication
(10) Pub. No.: US 2002/0138624 A1
(43) Pub. Date: Sep. 26, 2002

(54) Collaborative web browsing

(75) Inventor: Alan W. Esenther, Ashland, MA (US)

Correspondence Address: Patent Department, Mitsubishi Electric Research Laboratories, Inc., 201 Broadway, Cambridge, MA, 02139, US

(73) Assignee: Mitsubishi Electric Information Technology Center America, Inc. (ITA)

(21) Appl. No.: 09/814,190

(22) Filed: Mar. 21, 2001

(51) Int. Cl. G06F 15/16

(52) U.S. Cl. 709/227; 709/203

(57) ABSTRACT

A computerized system enables multiple users of standard Internet web browsers to collaborate by having significant states of their browser, such as which web page is currently being viewed, scrollbar positions, and form values, to be remotely controlled by users of other Internet web browsers. The system uses a monitor to poll the static and dynamic state of the selected pages, and to communicate the state with a controller executing on a web server. The content of the collaboratively viewed pages is arbitrary because viewed pages remain unmodified. Therefore, pre-existing web pages can be collaboratively browsed. Each of the users is optionally a sender or a receiver of selected web pages, and therefore is allowed to control which web pages are collaboratively viewed.

### FIELD OF THE INVENTION

This invention relates generally to the field of computer networks, and in particular to synchronizing access to network content by multiple users.

### BACKGROUND OF THE INVENTION

For some Internet browsing applications, it makes sense to synchronize multiple web browsers so that all users can concurrently view the same “target” web pages. This type of collaborative browsing is typically conducted in conjunction with telephone conversations, class room lectures, or perhaps, with Internet-based voice or text communications among the collaborating users.

A number of collaborative browsing systems are described in the prior art, see for example, U.S. Pat. No. 6,035,332 “METHOD FOR MONITORING USER INTERACTIONS WITH WEB PAGES FROM WEB SERVER USING DATA AND COMMAND LISTS FOR MAINTAINING INFORMATION VISITED AND ISSUED BY PARTICIPANTS;” U.S. Pat. No. 5,944,791 “COLLABORATIVE WEB BROWSER;” U.S. Pat. No. 6,009,429 “HTML GUIDED WEB TOUR;” U.S. Pat. No. 5,991,796 “TECHNIQUE FOR OBTAINING AND EXCHANGING INFORMATION ON THE WORLD WIDE WEB;” U.S. Pat. No. 6,151,622 “METHOD AND SYSTEM FOR PORTABLY ENABLING VIEW SYNCHRONIZATION OVER THE WORLD-WIDE WEB USING FRAME HIERARCHIES;” and U.S. Pat. No. 5,809,247 “METHOD AND APPARATUS FOR GUIDED TOURING OF INTERNET/INTRANET WEBSITES.”

In most prior art collaborative browsing systems, at least one of the users is designated as a “master” or sender, and other users are designated as “slaves” or receivers. Typically, the sender selects the target web pages that are collectively viewed by the viewers. In some systems, the receivers may also have the ability to assume the role of the sender.

As described below, existing collaborative browsing systems may be broadly classified in terms of the mechanisms that are used to direct the viewers to the selected pages.

One class of systems uses a “push” mechanism. There, a web server relies on a special HTTP header (Content-Type=multipart/mixed; boundary=“someString”) to keep a dedicated HTTP connection open between the server and each of the browsers executing the receivers' client computers. With this approach, the sender's browser sends the URL of each selected web page to a control program executing on the server. The server's controller then fetches the web page, perhaps processing its content, and pushes the page to each client receiver over the dedicated HTTP connections.

There are a number of problems with this class of systems. The most severe problem is that the push mechanism is not supported by all currently available Internet web browsers, for example, Microsoft's Internet Explorer. Also, the content of the web pages may need to be modified prior to sending in order to direct future requests to the controller. For example, all of the links in the pages may need to be processed so that these requests will be proxied through the controller in the future. This technique is only feasible for simple web pages. Complex pages can have numerous different HTML tags and Javascript commands that could trigger new requests without the control of the sender. It requires a non-trivial amount of effort, and in some cases delay to fully process arbitrarily complex web pages in this manner.

Furthermore, if the receiver directs the browser to some other page, then the dedicated HTTP connection is lost. It is possible to disable all of the links on the target web page by dynamically processing the target web page before it is sent to the receiver. However, this limits the role of the receiver to that of a totally passive observer. Disabling links also does not work when the receiver uses some other method to load a different web page. More important, modifying pages can alter their intended behavior. This solution also presents difficulties when the target web page contains HTML frames, or when caching is enabled, as described below.

Lastly, with the push mechanism, the receivers cannot have any type of control. The users are merely “pushed” to whatever pages that are selected by the sender.

In another class of collaborative browsing systems, a special monitor is installed on each of the collaborating computers. The monitor opens a dedicated socket connection to the controller. In this case, the sender's monitor tracks the activity of its web browser, and communicates information about updates to the controller where they can be relayed to the receivers' monitors. Apart from being very specific to particular browser implementations, the monitor program needs to be installed on each user computer before the users can collaborate. It is much more desirable to find a solution that does not require the installation of specialized programs, so that users can collaborate immediately even if they are collaboratively browsing for the first time ever.

In another class of collaborative browsing systems, browser “plug-ins” are installed in the web browsers. The plug-in behaves similarly to the monitor described above, and suffers from the same disadvantages.

Another class of collaborative systems, embodied by applications such as Microsoft NetMeeting, facilitates collaboration by essentially sharing all or part of the users' screens across a network. These may be considered complex, platform-specific and “heavy” approaches since they require greater bandwidth, pre-installation of binary executables, pre-registration, and user-training. As with other applications which are based on binary executables that are installed, such non-web-based approaches introduce software installation, configuration and maintenance issues. Arbitrary users cannot collaborate with such a system unless they all happen to use the same platform and happen to have met the installation, registration and training requirements ahead of time, and have sufficient bandwidth between them. It is desirable to find a solution which does not suffer from any of these requirements.

Another class of systems uses special downloadable programs, such as Java applets or similar technology. The applets execute on each web browser and open a dedicated socket connection to the controller. However, those systems do not work when Java is disabled in the browser. Even if Java is enabled, then it still takes a significantly larger amount of time to load and start the Java environment than it takes to load a simple DHTML web page, degrading performance. Furthermore, this class of systems typically requires embedding code in the target web pages, i.e., the “tag” to load the applets into the target web pages. This limits collaborative browsing only to such specially prepared web pages. If the special code is dynamically embedded into the page when the page is fetched, then there is the risk that modifications to the page will alter its intended behavior. A better solution, which does not require a modification of the target web pages, is desirable.

Existing systems may have other problems when the target web pages use HTML frames. If a new web page is loaded into a frame on the sender's browser, then the top-level URL of the web page is remains the same. In other words, the URL in the browser's “address” or “location” bar does not change. Therefore, a system which only monitors the top-level URL loaded into the sender's browser may not be aware that a frame on the sender's browser is displaying a web page which is different from the web page that is displayed in the corresponding frame on the receivers' browsers. Even if a URL change in a frame of the sender's browser is detected by some means, there is still the problem of forcing the web page at the new URL to be loaded into the corresponding frame for each receiver. It is desirable to find a solution where a change to any frames on the sender's browser is reflected in the receiver's browser.

For example, U.S. Pat. No. 6,151,622 “Method and system for portably enabling view synchronization over the world-wide web using frame hierarchies,” issued to Fraenkel, et al. on Nov. 21, 2000 described static synchronization of client Web browsers to a selected frame by generating a description of a hierarchy of the selected frame. The hierarchy was transmitted over a network environment and duplicated in target frames of the client browsers.

There a number of problems with that type of collaborative browsing. First, the captured frame hierarchy that is disseminated only includes static frame information, specifically the depth and name of the frame and the URL representing the frame content. Nothing is known or captured about the dynamic state of the selected frame. For example, if one of the users scrolls horizontally or vertically, or presses the “Page Down” key, then the views of the participants will no longer be synchronized. It is desirable to provide a collaborative web browsing solution in which the dynamic state of the web pages being viewed in each browser is also synchronized. Then, for example, if any user scrolls or types something into a form field, the browsers of the other users will be updated to reflect these dynamic state changes.

Furthermore the solution provided by Fraenkel et al. requires that the web page to be collaboratively viewed is loaded into a frame. There are a number of disadvantages with that approach. Some web pages will not behave properly if they are loaded into a frame rather than into the top-level document of the browser. Web pages which contain frames themselves are more prone to stop the browser from functioning. Web pages which are forced to be loaded into a frame cannot be book-marked, either. Finally, if a web page is forced to be loaded into a frame, then the URL of that web page will not be visible in the “Address” or “Location” field of the web browser, because only the URL of the top-level web page is shown in this field. It is desirable to provide a collaborative web browsing solution for which the web pages to be collaboratively viewed can be loaded as the top-level document of the web browser, such that they can be viewed in their “natural environment” just as if they were not being viewed collaboratively.

Finally, the solution provided by Fraenkel et al. puts the intelligence into collaboration scripts which are downloaded into each browser. Another solution would put this intelligence on the server rather than the clients so that the server can add value to the collaborative session. For example, the programs on the server could transform the dynamic or static state of collaboration information before disseminating that information to client browsers. In general, it may be advantageous to keep the intelligence in the server program because this program has ready access to auxiliary sources of information. Such sources of information might include back-end databases, information about the browser brands and versions in use by the clients, the screen resolution of each client, etc. It is desirable to provide a collaborative web browsing solution which is flexible and easily extended to support adding value to the collaborative web browsing sessions.

Prior art systems can have other problems when they rely on a sender's HTTP request for a new target web page to arrive at the host web server. This may be the case when the arrival of an HTTP request at the host is used as the basis to determine when a new target web page request by the sender must be processed. The problem is that web pages may be cached in the host server, or in some intermediate proxy server. If an HTTP request by the sender's browser is satisfied by a cache hit, then the request may not be reflected in the receiver's' web browser.

Therefore, it is desired to provide a collaborative web browsing system that includes dynamic state information and operates for pre-existing and arbitrary target web pages including any number of HTML frames, links, or Javascript. It also desired that the target web pages can be viewed naturally and without modifications that could alter their intended behavior. For accessibility and ease of use, it is also desired that the system does not require any special binary executables or programs such as Java applets or browser plug-ins.

### SUMMARY OF THE INVENTION

The present invention provides a flexible mechanism for synchronizing multiple web browsers. The invention enables unmodified web browsers to share unmodified web pages. This collaboration is made possible, in part, because any collaborating user can remotely control significant aspects of the browsers of other users using a “pull” or polling mechanism.

A “sender” browser selects the web pages to be viewed by “receiver” browsers. The receiver browsers can be “controlled” by one or more sender browsers. Any user browser can either be a sender or a receiver, or both. The invention operates by polling dynamic changes in states of the sender's browser, for example, resizing of the sender's browser window, selecting a new target page, scrolling the sender's browser window or frames, tracking pointer positions, and entering text. All changes in the dynamic state are reflected in the browsers of the receivers.

The invention comprises three main components: a controller executing on a host web server, and a monitor and target for each user participating in the collaborative web browsing system, whether as a sender, as a receiver, or as both.

The controller coordinates updates of the dynamic states of the various collaborating browsers. There is no restriction on the language used to implement the controller. For example, the controller can optionally be implemented as a PERL script, or as a Java servlet to provide platform independence.

The monitor includes an HTML web page including HTML frames, a configuration control panel, and Javascript programs. The monitor can execute in an instance of its own browser, or in one of the target's frames. The monitor knows the name of the target browser window, so the Javascript programs can detect any updates to the target window's dynamic state. The sender's monitor polls the sender's target to detect updates to its dynamic state to be transmitted to the controller. For example, if the sender scrolls the vertical scrollbar down in the target web page, then the sender's monitor detects this scrolling and transmits the scrolling state to the controller. Each receiver's monitor periodically polls the controller to detect the dynamic state updates to be reflected in the receiver's target.

The target is an instance of the browser, or one of its frames, including the target web page that is to be collaboratively viewed. According to the invention, the target can be a regular instance of any standard browser, as such, the target can be used for normal web browsing. Thus, the invention enables pre-existing and arbitrary web pages to be collaboratively viewed by unmodified browsers.

As mentioned above, the sender's monitor, executing in one browser instance or frame, thoroughly examines the state of the target web page that is loaded into the instance of the target browser instance or frame. The monitor performs this polling periodically at configurable time intervals, such as once every second. This examination determines the structure of the currently loaded target web page, and ascertains significant values to be transmitted to the controller. For simple web pages, this information minimally includes the top-level URL loaded into the page, and the positions of the horizontal and vertical scrollbars.

For web pages that use frames, the information also includes the URL used for each frame, and the scrollbar information for each frame. Other state information may include values typed into any forms on the web page, the text that is currently selected, and information related to the target web page. In addition, the dimensions of the target browser windows can be synchronized so that web content appears identically in all of the users' web browsers. Changes to any of these state values are transmitted to the controller in the form of polling requests, for example, HTTP or HTTPS request, or similar notifications in other communication protocols.

Due to security measures which are built into Javascript and standard web browsers, a Javascript program executing in a first browser instance (or frame) may only be allowed to access the detailed information in a second browser instance (or frame) when both instances are loaded with web pages from the same origin. In this case, the web pages, images and programs used to implement the invention should be stored on the same web server that stores the web pages to be collaboratively viewed.

In the case of a single sender, the state of the sender's target is reflected in all of the receivers' targets. In the case of multiple senders, the receiver is synchronized to the state of any of the senders. In particular, the receiver is synchronized to the state of the sender which made an update most recently. Each sender may also behave as a receiver so that all participant browsers are correctly synchronized with each other. A user may elect to be neither a sender nor a receiver. Such might be the case when, for example, that user wishes to leave the collaborative session briefly to browse elsewhere and then to return and re-join the collaborative browsing session at a later time.

When the sender's monitor transmits the update polling request to the controller indicating that some state, such as a scrollbar position, has changed, the controller dynamically generates an update message which contains details about the new state. This updates message is returned, in response to the periodic polling requests, to the receivers' monitors. The state changes are reflected in each receiver's browser instance (or frame), thus insuring that each receiver's browser is synchronized with all other browsers. The frequency at which the monitor polls for changes in state in either the target, in the case of a sender, or the controller, in the case of a receiver, is configurable via the control panel.

The method of the invention uses dynamic HTML techniques and does not require any special programs such as Java applets, browser plug-ins, or other executable programs to be installed on the user computers before collaboration can begin. Therefore, any arbitrary user on the Internet can collaborate with other users on the Internet immediately by simply visiting an initial web page. Users do not experience any initial delays such as those associated with prior art Java applets. Users may participate even if they are using a device with limited resources which does not support Java and similar “heavyweight” technologies.

The collaborative browsing system according to the invention is platform independent, and the controller executing on the host web server can be written in a platform independent language such as PERL, or Java.

The present invention enables more flexibility than known collaborative web browsing systems. Receivers can periodically browse elsewhere and then rejoin the collaborative session later. Rather than having one sender browser control all interactions, each user can optionally be a sender and therefore enabled to control the web pages to be collaboratively viewed by other receivers. Because the invention is a web-based application, support for new features can be added to the system without requiring any installation, configuration or maintenance of the user computers. Any such additions need only be made to the files on the host web server.

More particularly, the invention provides a method for collaboratively browsing web content in a network including a plurality of client computers and a server computer. S and dynamic states of a web page displayed in a first sender instance of a web browser are polled. The states are transmitted to a controller executing in a server computer over the network. In response to receiving the update messages, the controller generates update messages including the states. The controller is then polled by a second receiver instance of the web browser to receive the update messages, and the receiver browser can then display, and the web page can be displayed according to the states in the update messages so that the receiver's web browser is dynamically synchronize the sender's web browser.

### BRIEF DESCRIPTION OF THE DRAWINGS

FIG. 1 is a block diagram of a distributed collaborative web browsing system according to the invention;

FIG. 2 is a block diagram of monitor and target browser windows;

FIG. 3 is block diagram of a monitor web page structure;

FIG. 4 is an example listing of a target monitor request using HTTP;

FIG. 5 is pseudo-code from an update file;

FIG. 6 is a flow diagram of a method used by the controller to generate the updates file of FIG. 5;

FIGS. 7a, 7b, 7c are flow diagrams of methods used by the monitor to process changes by the user in the control panel, and to implement the monitor controller and target monitor components of the monitor; and

FIG. 8 is a flow diagram of an example user session.

### DETAILED DESCRIPTION OF THE PREFERRED EMBODIMENTS

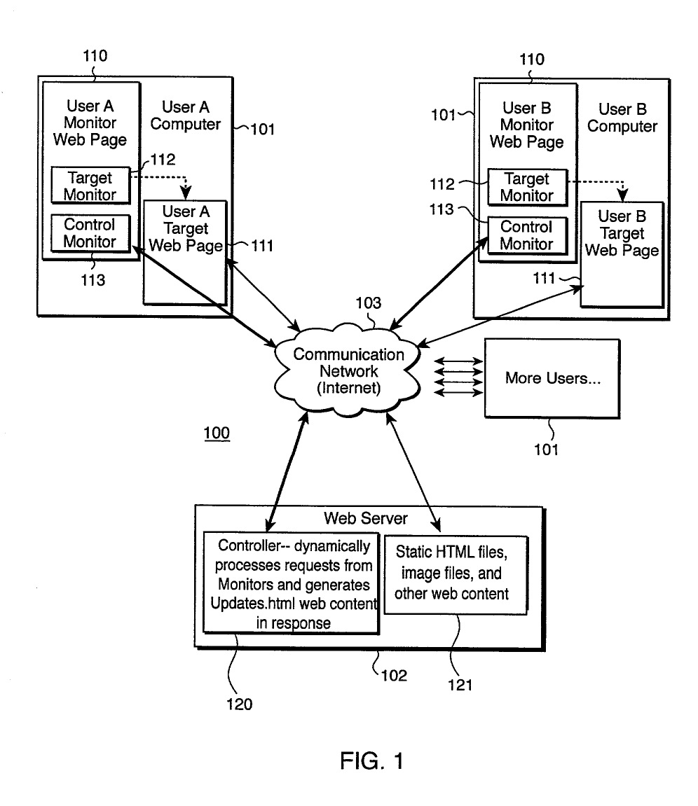

FIG. 1 shows a collaborative web browsing system 100 according to the invention. The system 100 includes one or more client computer (clients) systems 101, and a server (host) computer system 102 connected to each other by a network 103.

The clients 101 can be personal computers, workstations, laptops, personal digital assistants (PDA), wireless computing device such as cellular telephones and the like executing software programs. Operating system software can be Windows, LINUX, UNIX, NT, and so forth, application software can include Internet applications such as web browsers. The server can execute server software such as the Apache system. The clients and servers typically include input and output devices, and storage sub-systems. The network can be the Internet including the World-Wide-Web (WWW or web), and the links between the clients and server can be wire or wireless. The network can also include intermediate proxy servers and routers.

The three major components of the system 100 include a controller 120 in the server, and a monitor 110 and a target 111 for each of the clients 101. The monitor 110 can include a target monitor 112 and a controller monitor 113. In the case that the client is a multi-user system, the client can include an instance of the monitor and the target for each user.

The controller 120 is an application program executing on the server 102. The server can also store web content 121, such as web pages, image files, video files, etc., to be collaboratively viewed by the users of the system 100. The content can also be stored and cached in the clients, local servers, or the intermediate servers of the network.

The users of the system 100 can dynamically be enabled as “masters” or senders, as “slaves” or receivers, as both, or as neither. The content 121 selected and viewed by the sender is reflected in the targets 111 of all participating receivers. The target monitor 112 is enabled for senders, and the controller monitor 113 is enabled for receivers. The targets are instances of a standard unmodified web browser that can be loaded with various web content 121.

The target monitor 112 uses Javascript programs to periodically poll the dynamic state of the sender's target 111 to ascertain whether any changes in its dynamic state needs to be transmitted as updates to the controller 120. Any sender can load web content 121 to be collaboratively viewed into that sender's target. The controller monitors 113 communicate with the controller 120 using polling requests. The controller monitors fetch update messages generated in response to actions performed by the sender. Note that the present invention does not require that the monitor and target components exist in distinct web browser instances. The invention also allows these components to run in different frames of a single web browser instance, but in the preferred embodiment there are two distinct browser instances.

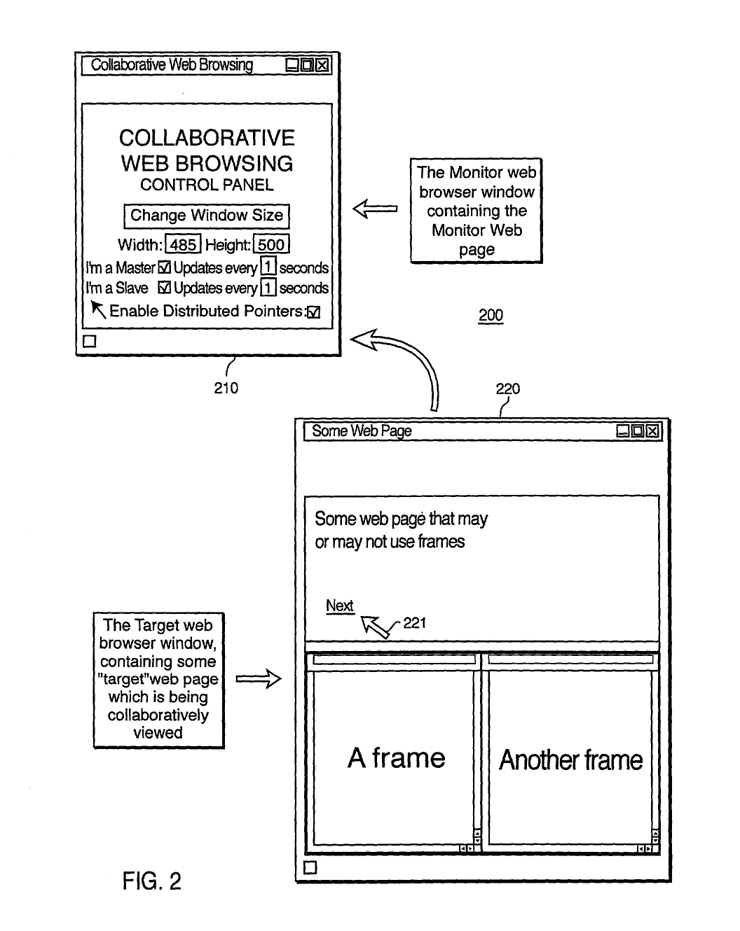

FIG. 2 shows the client side 200 of a preferred implementation of the invention wherein the monitor and target exist in separate browser instances, rather than in separate frames of the same web page. The web browser instance that contains the monitor initially displays a collaborative web browser control panel 210. This control panel is used to configure a collaborative browsing session. The target browser instance 220 is used by the sender to browse web pages that will be collaboratively viewed by receivers.

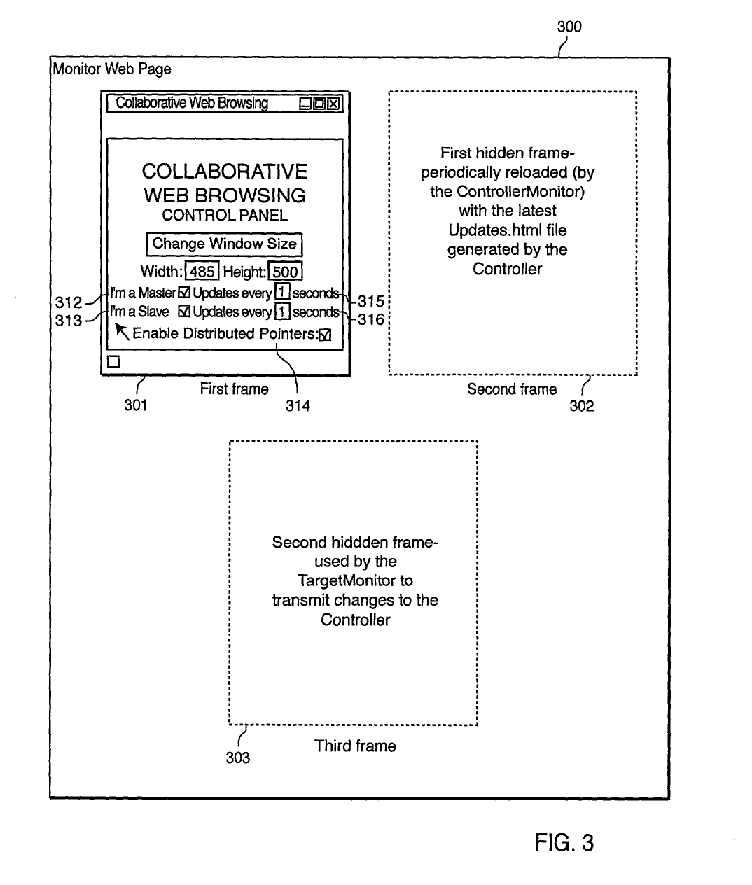

As shown in FIG. 3, the monitor web page 300 comprises three frames 301-303. A first frame 301 is visible. The other two frames 302-303 are “hidden” HTML frames not visible to the user. Effectively, hidden frames are zero-dimensional, i.e., they have no height or width.

The first frame 301 in the monitor web page 300 is the control panel 210. The control panel is used to configure certain aspects of collaborative browsing sessions. The user can use the control panel to specify 311 the dimensions of the target browser window 220. The user can also enable sender features 312, enable receiver features 313, and enable distributed pointers 314, described below. The user can also use the control panel to specify the frequency with which to poll for changes in dynamic state of the target window if the user is enabled as a sender 315, and changes from the controller if the user is enabled as a receiver 316. The first frame 301 also contains the Javascript programs that implement the target monitor 112 and the controller monitor 113.

The controller monitor periodically polls the controller by making polling requests. In the preferred embodiment, the requests follow the HTTP or HTTPS protocol. The response to this request is a web page that is referred to by the filename “Updates.html.” The Updates.html page is loaded into the first hidden frame 302. The content of the Updates.html file indicates whether any changes have been made to the dynamic state of the target web page of any sender users. If some changes have been made, such as when a new web page has been loaded into the target browser window for a sender, then those changes will be applied to the local target window. The Javascript programs in the controller monitor are only enabled for a receiver.

The target monitor 112 periodically polls the dynamic state of the web page that is currently loaded into the target window 220. Any changes to the state of the target web page are transmitted to the controller 120, which will make the changes available for all receivers. In the preferred embodiment, these changes are transmitted to the controller as parameters in HTTP requests. The HTTP response to this request is loaded into the second hidden frame 303. The HTTP response from the controller is used for debugging. The Javascript programs that implement the target monitor are only enabled if the local user is enabled as a sender.

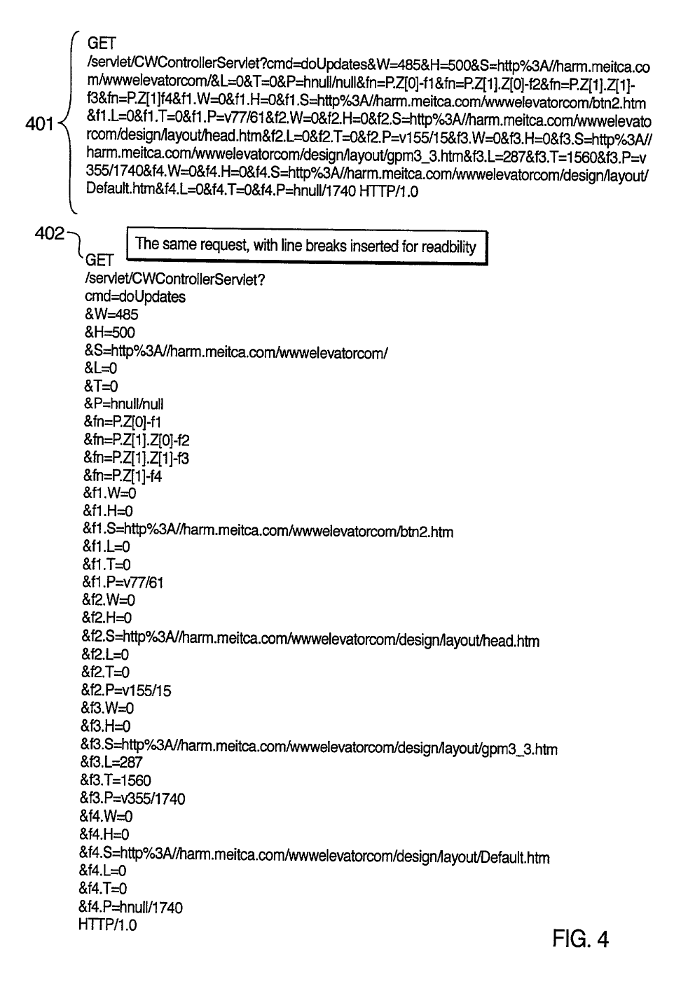

FIG. 4 shows an example polling request made by the target monitor 112 when it sends dynamic state updates to the controller 120 in a compact 401 and expanded 402 form. In this example, the HTTP GET method is used. Alternatively, the HTTP POST method may be used, perhaps when there is a large amount of data in the update. The target monitor may dynamically decide whether the GET or POST method is the most appropriate for a particular set of updates.

In the example shown in FIG. 4, the HTTP parameter names and values are encoded via simple text substitutions for brevity. For example, strings of the form “frames[” are replaced with strings “Z[”. Note that information about each frame in the target window is encoded using query parameter names of the form “fn.d,” where “n” is a number that indicates a particular frame and “d” indicates a particular attribute of that frame. For example, “fi.S” indicates the URL of web page that is loaded into the frame designated “f1.” The encodings for these frame designations are also included in the query parameters, e.g., “fn=P.Z[1].Z[0]−f2” indicates that attributes for nested frame frames[1].frames[0] will be contained in query parameters with names that start with “f2.” It is recognized that other methods for encoding the parameter names and values may be used, and that the method used may be tailored to best match the environment and communication mechanism with which the invention is being used, e.g. if the SOAP protocol is used, the data could be sent using an XML format.

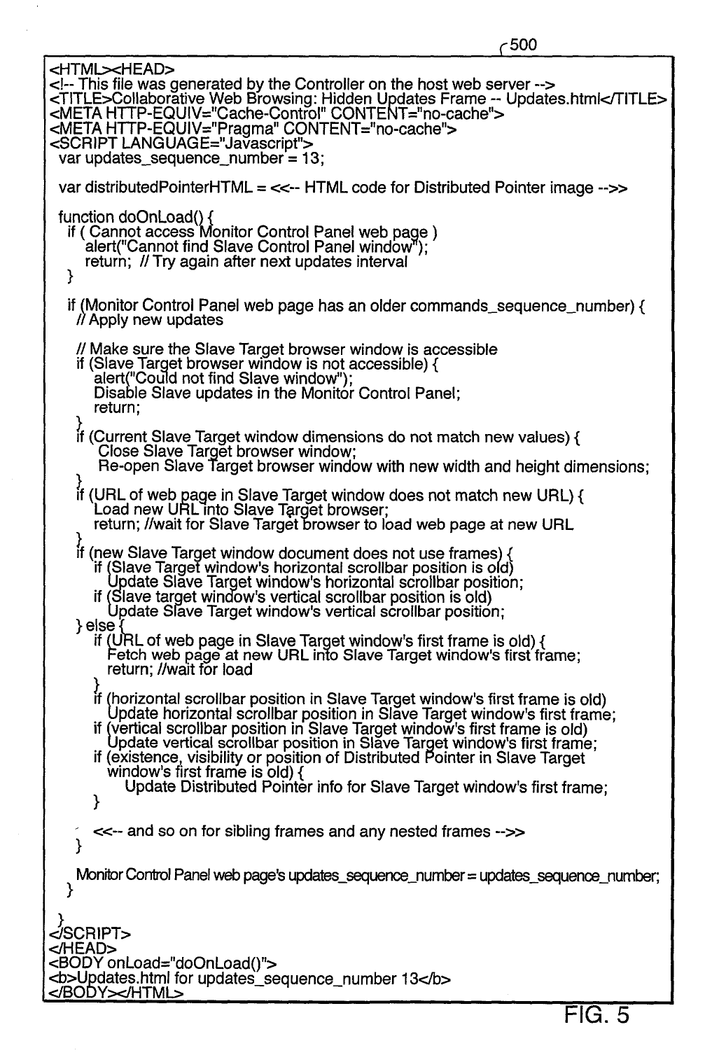

FIG. 5 shows an example Updates.html file 500. This is the file that is generated by the controller 120 in response to updates from the target monitor on a sender. This file is periodically fetched by the controller monitor on each receiver. Note that Updates.html is loaded into the second frame 302 of the monitor web page. Note the “onLoad” handler in the pseudo-code. This handler is executed when this web page has finished loading into the browser. It explicitly compares the dynamic state attribute values in the updates with those in the web page in the receiver's target browser. If any attribute value does not match, then it's value is updated, by Javascript code in Updates.html, in the receiver's target browser. Note that in FIG. 5 the word “slave” indicates the “receiver”.

The flow of control in the Updates.html file 500, which is used to update the receiver's target web page 220, should be evident to one skilled in the art. Sequence numbers are used to verify whether the particular set of changes reflected in this Updates.html file have been processed, yet. Note that attributes in any sub-frames are recursively updated, too. Browser-specific Javascript commands may be used as needed to update the receiver's target web page 220, because, if necessary, the controller and monitor are able to detect the platform and version information about the web browser's in use using standard Javascript Document Object Model methods and properties. It is recognized that the format and use of Javascript in FIG. 5 represents only one of many potential ways of conveying the updates information for transmission to the receivers. This format is used in the preferred embodiment for clarity and simplicity of operation.

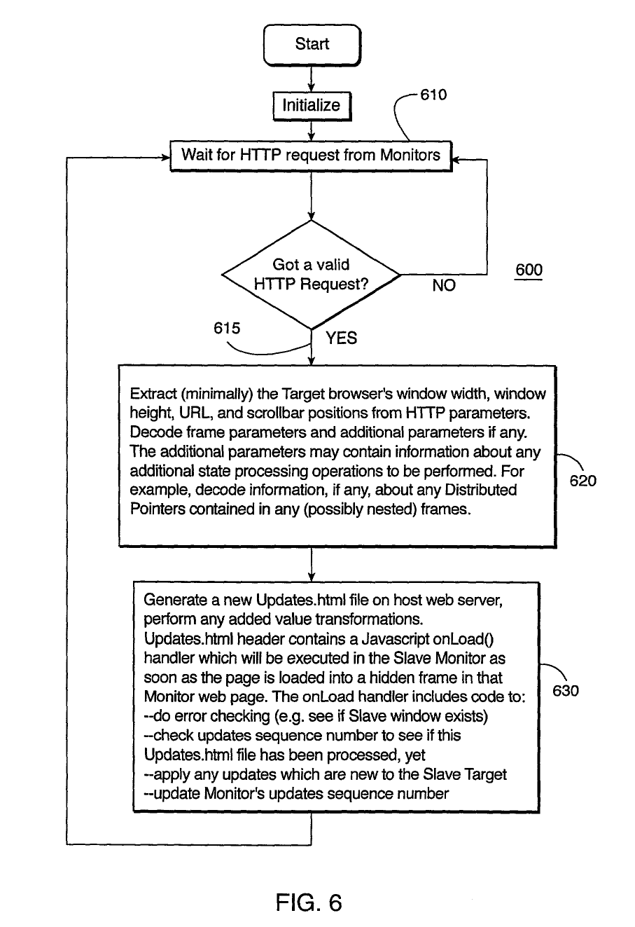

FIG. 6 shows a method 600 used by the controller 120 to process updates from a sender. The method waits for a polling request 610. When a valid request is received 615, the dynamic state of the target browser is extracted 620 to generate 630 a new Updates.html file 500.

The controller program 120 running on the host web server 102 is designed to wait for valid requests 610 from a monitor. Upon detecting such a request 615, the controller extracts (typically for minimal level of functionality) the target browser's window width, window height, URL, and scrollbar positions from the HTTP parameters. This includes any URL and scrollbar positions for frames, if any, used in the target web page. Additional parameters may also be decoded which may contain information about additional state processing information to be conveyed to the receivers. For example, these additional parameters may contain information about how an HTML form is being filled in, what text is being selected, and the existence and location of any Distributed Pointers, described below, any of which may be available in any possibly nested frame in the target web page.

After extracting the information about updates which a sender has made to the target web page, the controller generates 630 a new Updates.html file 500 on the host web server 102. As shown in FIG. 5, this Updates.html file contains a Javascript onLoad event handler which is executed when the Updates.html file has finished loading into the receiver's hidden frame 302. This onLoad handler includes code to do error checking (e.g. see if the receiver target window is still open and accessible), to check an updates sequence number to see if this particular Updates.html file has been processed, yet, to apply any new updates to the receiver's target web page, and finally to update the receiver monitor's updates sequence number to indicate that this set of updates has been applied.

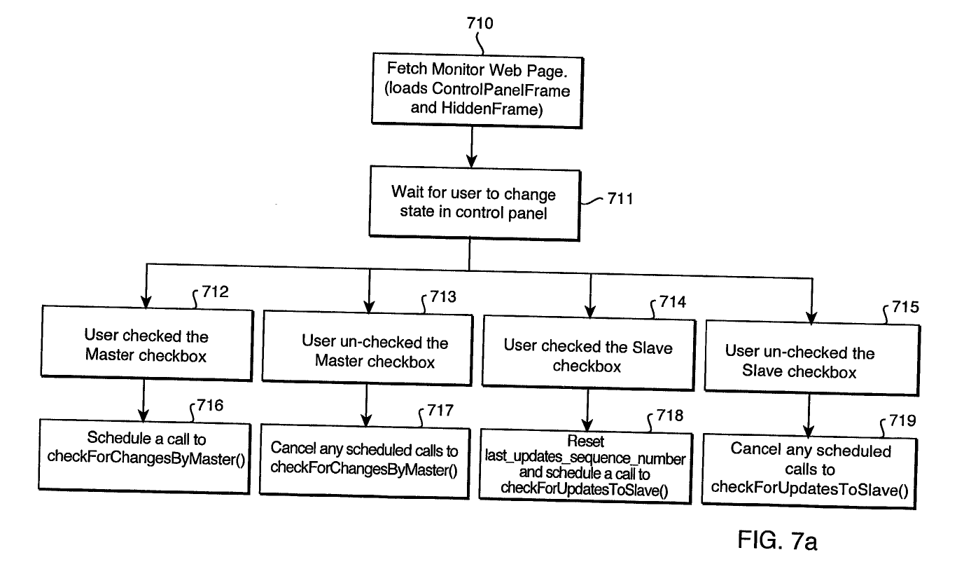

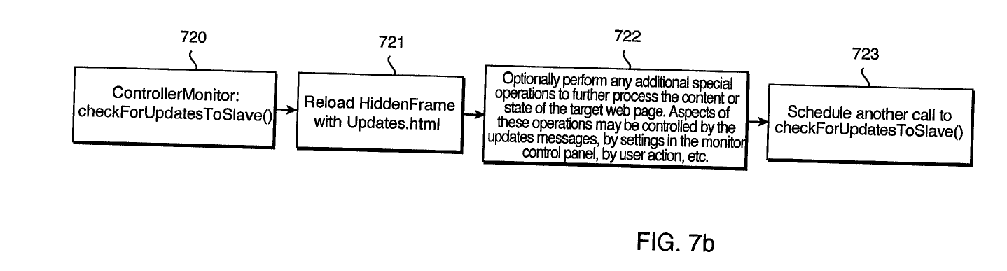

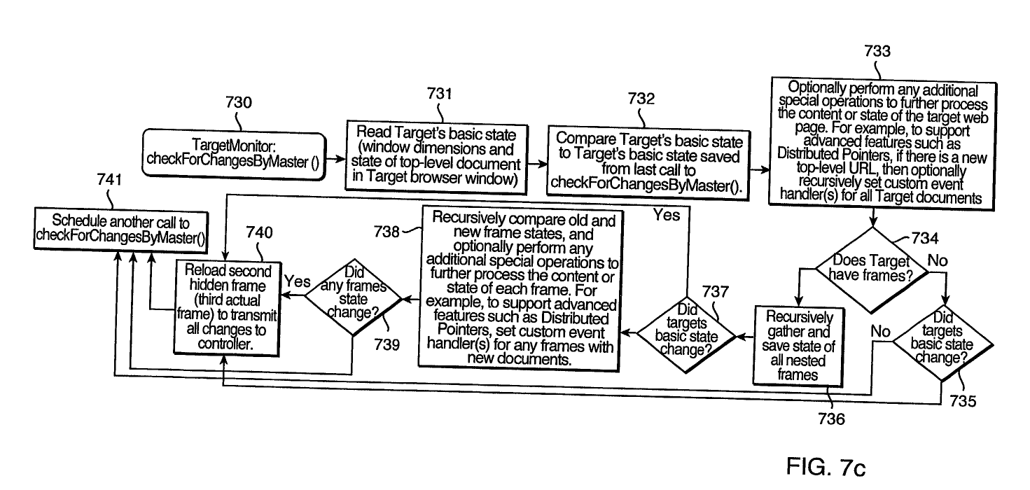

FIGS. 7a, 7b, 7c show methods used by the monitor to operate the user's control panel 710-719, methods used to implement the controller monitor 720-723, and methods used to implement the target monitor 730-741.

FIG. 7a shows the method used by the monitor to respond to configuration changes made by the user via the control panel. As shown in FIG. 7a, initially, the monitor web page, containing the control panel 301 and two hidden frames 302-303, is loaded 710 into the monitor window or frame 210. Standard event handlers associated with form elements in the monitor control panel 210 are used to respond to configuration changes made by the user. This is indicated in FIG. 7a at block 711 where the method waits for the user to change some state in the control panel. If the user checks 712 or un-checks 713 the “Master” (sender) checkbox then a call is either scheduled 716 or any existing scheduled calls are canceled 717, respectively, to the TargetMonitor routines in checkForChangesByMaster( ) 730. Similarly, if the user checks 714 or un-checks 715 the “Slave” (receiver) checkbox then a call is either scheduled 718 or any existing scheduled calls are canceled 719, respectively, to the ControllerMonitor routines in checkForUpdatesToSlave( ) 720. In addition, if the user un-checks the Slave checkbox 714, then a “last_updates_sequence_number” counter in the ControllerMonitor is reset 718 so that the receiver will be properly re-synchronized when this checkbox is checked again. Otherwise the ControllerMonitor might think that this receiver is already up-to-date.

FIG. 7b shows the method used by the controller monitor 113 in receivers to regularly monitor the controller such that new updates from senders will be detected and applied. In other words, the checkForUpdatesToSlave( ) controller monitor routine is used to update the receiver (slave). If the monitor is configured as a receiver (the Slave checkbox 313 is checked), then the checkForUpdatesToSlave( ) controller monitor routine is regularly called 720.

The frequency with which this routine is called can be configured in the monitor control panel 316. This method simply reloads 721 the first hidden frame 302 in the monitor web page 300 with the most recent Updates.html file 500 which was generated by the controller 120 on the host web server 102. The onLoad handler in the Updates.html file will apply any needed updates, as explained earlier. The controller monitor may optionally perform any additional special operations 722 to further process the content or state of the receiver's target web page. These operations may be used to add additional value to the collaborative web browsing session. Aspects of these operations may be controlled by the updates messages, by settings in the senders or receivers monitor control panel, or by user action, for example. Finally, the controller monitor checkForUpdatesToSlave( ) routine re-schedules another call to itself 723 after the interval specified in the control panel 316 so that the next set of updates will be applied, too.

FIG. 7c shows the method used by the target monitor 112 in senders to regularly monitor the sender's target web page such that any changes will be transmitted to the controller. In other words, the checkForChangesByMaster( ) target monitor routine is used to check for any changes made by this sender (master) and if so to transmit them to the controller for relaying to receivers. If the monitor is configured as a sender (the Master checkbox 312 is checked) then the checkForChangesByMaster ( ) target monitor routine is regularly called 730.

The frequency with which this routine is called can be configured in the monitor control panel 315. This method first reads the basic (static and dynamic) state of the target window 731, which minimally includes the window dimensions and state of the top-level document in the target browser window. The state of the top-level document may minimally include the URL loaded into the top-level window, and the positions of the horizontal and vertical scrollbars. Next the target's basic state is compared to the basic state saved in the target monitor during the previous call to checkForChangesByMaster( ) 732.

Before using the results of that comparison, the target monitor routine may first optionally perform any additional special operations to further process the content or state of the target web page 733. These operations may be used to add additional value to the collaborative web browsing session. Aspects of these operations may be controlled by settings in monitor control panel or by user action, for example. As an example, to support advanced features such as distributed pointers, described below, if there is a new top-level URL detected in the target web window then at this point the target monitor routine could recursively set custom event handler(s) in the target window to detect the existence or movement of such distributed pointers.

Continuing in FIG. 7c, the target monitor checkForChangesByMaster( ) routine checks to see if the target web page uses frames 734. If not, it checks to see whether the target's basic state changed (this was ascertained earlier 732). If the targets basic state did not change and there are no frames, then there are no updates to be transmitted to the controller, so the method simple schedules another call to itself 741 after the interval specified in the control panel 315. If the target does not have frames 735, but it's basic (top-level) state did change, then the method reloads the second hidden frame 303 (the third actual frame) in the monitor web page to transmit all changes to the controller 740. The idea here is that the HTTP request to reload the second hidden frame is directed to the controller and contains the update information as parameters. The controller decodes the update parameters and sends some web page document in response which is loaded into the second hidden frame 303. This response document is not used apart from transmitting status (e.g. “successfully received updates”) and debugging.

Continuing in FIG. 7c, if the target monitor does use frames 734, then the checkForChangesByMaster( ) routine recursively gathers and saves static and dynamic state of all (possibly nested) frames in the target web page 736. If the target's basic state changed 737 (as was ascertained earlier 732), then the second hidden frame is reloaded in order to transmit those changes to the controller 740, as described above. Note that when the target uses frames and the target's basic state has changed, the method does not bother recursively looking for changes in the frames. This is because changes in the basic top-level state of the target must be handled first. As an example, if the top-level URL has changed, then receiver's will have to load the new top-level URL before they can be allowed to change any frame located in the web page specified by that top-level URL.

If the target is using frames, but the target's basic state has not changed since the last time that checkForChangesByMaster( ) was called 737, then the method recursively compares 738 old and new frame states and optionally performs 738 any additional special operations (as described earlier for the top-level documents 733). Next, continuing the case where the target has frames and the target's basic state has not changed, the method checks to see if any (possibly nested) frame's state has changed 739. If so, the second hidden frame 303 is reloaded in order to transmit those changes to the controller 740, as described earlier.

In any event, the last step of any call to checkForChangesByMaster( ) 730 is to schedule another call to checkForChangesByMaster( ) 741 after the interval specified in the control panel 315.

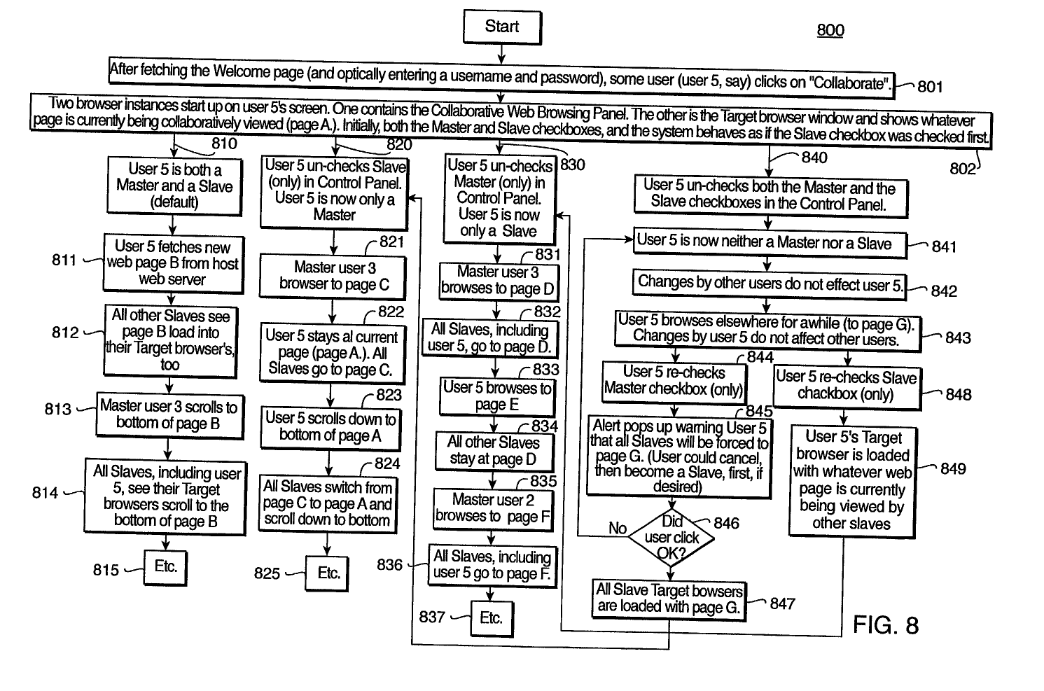

FIG. 8 shows an example flow of operations for typical user sessions when the user is operating as a sender and receiver 810, only as a sender 820, only as a receiver 830, and as neither a sender or receiver 840. In this figure, the word “slave” refers to a receiver, and the word “master” refers to a sender. This figure by no means shows all of the sequences of operations which are covered by the invention, but it conveys enough information to give someone skilled in the art the idea of how it is intended to operate.

As shown in FIG. 8, the typical way in which a user might join a collaborative web browsing session. This user will hereby be referred to, arbitrarily, as “user 5” to distinguish him or her from other users who may already be taking part in this collaborative web browsing session. User 5 initially fetches a special “Welcome” web page 801 in which user 5 might optionally enter a username and password before clicking on a “submit” or “Collaborate” button. This invention does not require password-protected pages, but they may be used, if desired, using standard password-protection mechanisms. In the preferred embodiment, the monitor web page and the user's target web page run in distinct web browser instances. Assuming this is the case, then upon clicking the “submit”/“Collaborate” button 801, two new browser instances will open on user 5's screen 802. The first instance contains the monitor control panel 210, and the other contains the target web page 220. For this scenario we will say that initially both the “Master” (sender) checkbox 312 and the “Slave” (receiver) checkbox 313 are checked in the control panel, and the system will behave as if the Slave checkbox was checked first. This implies that at this point user 5's target browser window will be loaded with the web page that is currently being collaboratively viewed. (Note that if the system initially behaved as if the Master checkbox was checked first, then the target browser of every Slave/receiver currently in the session would immediately be loaded with the same page as is initially loaded into user 5's target browser window.)

Since, initially, in this scenario user 5 is configured by default as both a Master and a Slave, the first path 810 in FIG. 8 will be traversed. This path 810 describes the behavior of the collaborative web browsing system when user 5 is both a Master and a Slave (which is the default). As an example flow of control under this path, user 5 may then fetch a new web page (page B) from the host web server into user 5's target browser window 811. Since user 5 is configured as a Master, all of the other slaves will automatically have page B loaded into their target browser windows, too 812. Next, say that master user 3 scrolls to the bottom of page B 813. In response, all slaves, including user 5, will see page B in their target browser windows automatically scrolled to the bottom of page B, too 814. And so on 815—since user 5 is a master and a slave, user 5 can both control what appears in all slave target browsers, and can see any changes that any other masters make in their target browsers.

If user 5 un-checks the Slave checkbox 313 in the control panel 210, but leaves the Master checkbox 312 checked, then user 5 will now only be a master 820. In this case, the second path 820 in FIG. 8 will be traversed. This path 820 describes the behavior of the collaborative web browsing system when user 5 is a Master, but not a Slave. As an example flow of control under this path, say that all of the slaves currently have web page A loaded into their target browser windows, but then master user 3 now fetches a new page, page C, into user 3's target browser 821. Since user 5 is not configured as a slave, user 5 will stay at page A and will not see page C loaded into user 5's target browser window, although any and all other slaves in this session will 822. Now say that user 5 scrolls down to the bottom of page A 823. Since user 5 is configured as a master, all slaves will suddenly see their target browser's loaded with page A, and then scrolled to the bottom of page A as they become synchronized with the most recent change by any master 824. And so on 825—since user 5 is a master but not a slave, user 5 will not see any changes that other master's make, but all slaves will see changes that user 5 makes.

If user 5 un-checks the Master checkbox 312 in the control panel 210, but leaves the Slave checkbox 313 checked, then user 5 will now only be a slave 830. In this case, the third path 830 in FIG. 8 will be traversed. This path 830 describes the behavior of the collaborative web browsing system when user 5 is a slave, but not a master. As an example flow of control under this path, say that master user 3 browses to a new web page, page D, in user 3's target web browser 831. All of the slaves, including user 5, will see their target web browsers loaded with page D 832. Now say that user 5 browses to page E 833. Since user 5 is not configured as a master, all of the other slaves continue to stay at page D 834. Now say that master user 2 browses to page F 835. Then all of the slaves, including user 5 will see their target web browsers automatically loaded with page F 836. And so on 837—since user 5 is a slave but not a master, user 5 will see any changes that other masters make, but other slaves will not see any changes that user 5 makes.

If user 5 un-checks both the Master checkbox 312 and the Slave checkbox 313 in the control panel 210, then user 5 will now be neither a master or a slave 841. In this case, the fourth path 840 in FIG. 8 will be traversed. This path 840 describes the behavior of the collaborative web browsing system when user 5 is neither a master nor a slave. In this case any changes by other users will not be seen by user 5 842. Furthermore, any changes made by user 5, such as browsing to a new web page, page G, will not be seen by other users 843. Therefore, user 5 is not currently participating in the collaborative web browsing system. User 5 may elect to do this if, for example, they wish to find a web page to share, but they must surf around for awhile to find that page. While user 5 is surfing around to find the page which user 5 wishes to share, user 5 may uncheck both the master and slave checkboxes so that user 5 will not be bothered with changes made by other masters, and so that other slaves will not see intermediate pages that user 5 loads while looking for the page which user 5 wishes to share.

Continuing the case in FIG. 8 where user 5 is neither a master nor a slave, say that eventually user 5 browses to page G 843, which user 5 wishes to share with slaves in the collaborative web browsing session. If user 5 wishes to re-join as both a master and a slave, then the order in which user 5 re-joins the session at this point is critical. If user 5 first re-checks the Slave checkbox 848 (leaving the master checkbox unchecked), then page G in user 5's target browser will immediately be “over-written” as user 5's target browser is loaded with whatever web page is currently being viewed by other slaves 849. At this point user 5 is participating as a slave but not a master 830. This may be the desired behavior if user 5 was browsing elsewhere and now wishes to see what everyone else is viewing in the session, but say that user 5 really did want to share page G with all of the other slaves in the session. In that case user 5 should check the master checkbox 844 before checking the slave checkbox (or user 5 may elect not to check the slave checkbox at all). Since user 5 is joining the session as a master, an alert pops up on user 5's window warning user 5 that all slaves will be forced to view page G (or whatever page is currently loaded into user 5's target web browser). This warning alert is done as a precaution so that someone joining or re-joining a session as a master does not accidentally and unintentionally redirect all of the slave target browsers. If user 5 clicks “OK” 846, indicating that user 5 really does intend for all slaves to be re-direct to the page (page G in this case) that user 5 is currently viewing, then all of the slave target browsers are immediately loaded with page G 847. At this point user 5 is participating in the session as a master, but not a slave 820. If, on the other hand, user 5 clicks “Cancel” when asked in the pop-up alert whether user 5 really intends to redirect all of the slaves, then user 5 will remain as neither a master or a slave 841.

The information transmitted between the controller on the web server and the monitor in the user browser instances can be in a number of formats. In the preferred embodiment, and for clarity and simplicity, the information is contained in dynamically generated executable Javascript statements that can be executed in the receiver web browsers as is. To improve performance, a more concise format could be used. To improve interoperability and leverage new and existing XML tools and protocols (such as SOAP), an XML format could be used. Also note that in the preferred embodiment, whenever any part of the state changes, the entire dynamic state is transmitted to all users, not just the part of the state that changed. This assures that users can join the collaborative web browsing session at any time and get up-to-date with all of the state—not just the latest changes. Again, for better performance, another implementation can just send information about state that changed so that the messages exchanged would be smaller. In this case, additional dynamic state information can be requested and transmitted as required.

In an alternative embodiment, it is not necessary for the user's control panel, and its associated control programs, to execute in a separate browser instance. The user's control panel and control programs can all be loaded into one of two frames, where the other frame contains the target web page being collaboratively viewed. The advantage of this embodiment is that it only requires one instance of the browser to be running on each user's computer. One disadvantage of the frames approach is that it imposes limitations on the types of web pages that can be collaboratively viewed. This is because, as an example, some web pages do not behave in the way in which the web author intended when they are viewed within a frame rather than as a top-level document. By using two browser instances, the content of the viewed pages is arbitrary because the viewed pages are running in their own browser window, just as if they were not being viewed collaboratively. Other disadvantages of loading the target web page into a frame are that the URL of the target web page will not be visible in the browser's “Location” or “Address” field, and the target web page cannot be bookmarked using a feature of the web browser such as “Add to Favorites” or “Add Bookmark”.

To facilitate cross-platform and cross-browser independence, Javascript is preferred as the scripting language to implement this invention in the user web browsers. Any other programming language, variation of Javascript, or other mechanism, which allows access to the Document Object Model of a web browser, may be substituted for Javascript. Note that, since the Document Object Model may differ between web browser brands, browser-specific Javascript code may be used as needed to access parts of the state of the target web page documents.

A number of enhancements to the basic collaborative web browsing system can be implemented. Where desired, standard mechanisms can be used to password-protect the collaborative web-browsing sessions, and to maintain multiple independent sessions. It is also advisable and straight-forward to add administrative interfaces to the controller running on the web server such that a GUI representation of aspects of the collaborative web browsing system can be dynamically viewed and used for management. For example, one such interface might be used initially to establish a new dedicated collaborative web browsing session with a user seeking help about a particular web site.

As another example of an enhancement, it is possible to allow a sender to control additional aspects of other user's browsers. Minimally, each sender reflects changes to any sender's window size, the currently loaded web page address (URL), the scrollbar positions, and the URL and scrollbar positions of any frames that the web page contains. However, this functionality can be extended to track any other object that the Javascript Document Object Model allows access to for that browser. For example, it may be desirable to track textual user input as it is entered into a text field in a form on a web page, so that all users will see what any user types into such a field. Similarly, other form elements, such as checkboxes and pull-down listboxes can be collaboratively modified. Arbitrary text selections could also be shared. I.e. if a master selects a paragraph of text, all slaves would see that paragraph of text selected in their browsers, too.

The preferred embodiment allows each user to decide whether to participate in a session as a sender, as a viewer, or as both. It is foreseen that there are applications of this invention where users are not given all of these options, or where one or more of the options are password-protected. For example, in an online classroom situation, it may be desired that the instructor is the only sender and that all students are viewers.

The present invention can also provide distributed pointers, which greatly enhance the level of collaboration in the collaborative session. A distributed pointer is a pointer which all users in the session may see and which all users may (optionally) move. Without such distributed pointers, it may be difficult for collaborating users to know for sure which part of a web page or frame is being discussed. Any sender may generate one or more distributed pointers in the target web page currently being collaboratively viewed 220. Each pointer 221 is generated by inserting HTML pointer code into the target web page. The pointer code generates an HTML layer on top of the existing target web page. This layer is created at the place on the web page at which the user indicates, perhaps with a special keyboard and mouse click combination.

Each layer contains an image of a pointer, but is otherwise transparent. The sender can then move the pointers around the target page using standard mouse clicking and dragging procedures. State information about the presence, visibility and position of each pointer is reflected in each of the receiver's browsers using the methods described earlier for other dynamic state (such as scrollbar positions). Any sender can control the visibility and position of any of the distributed pointers.

The infrastructure for sharing content and state according to the present invention can also be extended, using mechanisms that should be reasonably obvious to one skilled in the art, to facilitate other features. For example, note that in this invention, the controller acts as an intelligent central location through which updates are relayed. Therefore the controller may be enhanced to add value to the collaborative web browsing sessions. Example enhancements include a purely DHTML-based chat capability, purely DHTML-based sharing of web content dynamically generated by users, and loading web pages from foreign domains into remote user's browsers (URL sharing). It is straightforward to add capabilities in the controller to support categories of users, such that, for example, only users who have subscribed to some type of content will receive particular updates. In addition, by time-stamping and saving each update, it becomes possible to “play back” a collaborative browsing session at a later time.

Having an intelligent controller in the framework provided by the present invention allows one to dynamically transform the content of the pages being collaboratively viewed. For example, the controller may be enhanced to transform updates received by a sender before they are disseminated to receivers. As a few examples, the controller might transform updates to adjust for different browser brands or versions being used by different participants, to adjust for language differences between different participants, or to control the views available to each participant based on some content subscription or security scheme. Controls such as buttons or (cascading) pull-down menu lists may be included in the monitor control panel to enable, disable or control aspects of any such transformations. Alternatively, it may be more appropriate to provide a dedicated administrative (presumably web-based) GUI interface to the controller to control these kinds of transformations.

It is also recognized that there may be situations in which a user would rather explicitly initiate one synchronization, perhaps by pressing a button, rather than enabling the continuous polling mechanism in the preferred embodiment. This can be facilitated by adding a simple “Refresh” (for receivers) &/or “Send Updates” (for senders) button to the Monitor Control Panel.

It should be noted that this invention uses lightweight techniques (DHTML) and simple existing protocols (HTTP, HTTPS, or perhaps SOAP) to facilitate collaboration while avoiding firewall penetration problems. Therefore, this invention can advantageously be used to facilitate collaboration on limited-resource devices, such as handheld devices. Such devices might not lend themselves as well to a heavier approach which relies on Java or ActiveX controls, for example. More importantly, by targeting the invention to use standard and simple mechanisms, the base of potential users is much greater.

The invention is described in terms that enable any person skilled in the art to make and use the invention, and is provided in the context of particular example applications and their requirements. Various modifications to the preferred embodiments will be readily apparent to those skilled in the art, and the principles described herein may be applied to other embodiments and applications without departing from the spirit and scope of the invention. Thus, the present invention is not intended to be limited to the embodiments described herein, but is to be accorded with the broadest scope of the claims below, consistent with the principles and features disclosed herein.

I claim:

1. A method for collaboratively browsing web content in a network including a plurality of client computers and a server computer, comprising:
polling static and dynamic states of a web page displayed in a first instance of a web browser;
transmitting the states to a controller over the network;
generating, in the controller, update messages including the static and dynamic states; and
polling, in a second instance of the web browser, the controller to receive the update messages over the network; and
displaying, in a second instance of the web browser, the web page according to the states in the update messages to dynamically synchronize the second instance of the web browser to the first instance of the web browser.

2. The method of claim 1 wherein there are multiple instances of first and second instances.

3. The method of claim 1 wherein the polling of the states is performed in a monitor executing in first instance of the web browser, and the polling of the controller is performed in the second instance of the web browser.

4. The method of claim 1 wherein the retrieved target web pages is stored in the server.

5. The method of claim 1 wherein the polling is performed by polling requests.

6. The method of claim 1 wherein the first and second instances of the web browser execute in the client computers, and the server executes in a server computer.

7. The method of claim 1 wherein the web page is selected by a user of the first instance of the web browser.

8. The method of claim 1 wherein the web page and all instances of the web browser remain unmodified during the collaborative browsing session.

9. The method of claim 4 wherein responses to the polling requests are loaded into a hidden browser frame, a hidden layer, or another browser window.

10. The method of claim 9 wherein the hidden browser frame is zero dimensional.

11. The method of claim wherein the controller transforms dynamically transforms the update messages.

12. The method of claim 1 further comprising:
polling static and dynamic states of another web page displayed in the second first instance of a web browser;
transmitting the states to a controller over the network;
generating, in the controller, update messages including the static and dynamic states; and
polling, in the first second instance of the web browser, the controller to receive the update messages over the network; and
displaying, in the first second instance of the web browser, the other web page according to the states in the update messages to dynamically synchronize the first instance of the web browser to the second instance of the web browser.
